(19) United States
(12) Patent Application Publication
(10) Pub. No.: US 2026/0059364 A1
(43) Pub. Date: Feb. 26, 2026

(54) BEAMFORMING CODEBOOK CONFIGURATIONS FOR PREDICTIVE BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 19/102,335

(22) PCT Filed: Oct. 2, 2022
(86) PCT No.: PCT/CN2022/123675

§ 371 Date: Feb. 7, 2025

(51) Int. Cl. H04W 24/10; H04B 7/06

(52) U.S. Cl. CPC H04W 24/10; H04B 7/0617; H04B 7/0626

(57) ABSTRACT

Certain aspects relate to beamforming codebook configurations for predictive beam management. For example, an apparatus may receive, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. The apparatus may transmit, to the network entity, a channel measurement report indicating one or more predicted channel metrics associated with at least a subset of the second set of resources based on the beamforming codebook and the first set of resources.

### BACKGROUND

### Technical Field

The present disclosure generally relates to communication systems, and more particularly, to beamforming codebook configurations for predictive beam management.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

There exists a need for further improvements in 5G NR technology. These improvements may also be applicable to other multi-access technologies and the telecommunication standards that employ these technologies. For instance, improvements to efficiency and latency relating to mobility of user equipments (UEs) communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a method for wireless communication at a user equipment. In some examples, the method includes receiving, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. In some examples, the method includes transmitting, to the network entity, a channel measurement report indicating one or more predicted channel metrics associated with at least a subset of the second set of resources based on the beamforming codebook and the first set of resources.

Certain aspects are directed to a method for wireless communication at a network entity. In some examples, the method includes transmitting, to a User Equipment (UE), a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. In some examples, the method includes receiving, from the UE, a channel measurement report indicating one or more predicted channel metrics associated with at least a subset of the second set of resources based on the beamforming codebook and the first set of resources.

Certain aspects are directed to an apparatus configured for wireless communication, comprising a memory comprising instructions and one or more processors configured to execute the instructions. In some examples, the apparatus is configured to receive, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. In some examples, the apparatus is configured to transmit, to the network entity, a channel measurement report indicating one or more predicted channel metrics associated with at least a subset of the second set of resources based on the beamforming codebook and the first set of resources.

Certain aspects are directed to an apparatus configured for wireless communication, comprising a memory comprising instructions and one or more processors configured to execute the instructions. In some examples, the apparatus is configured to transmit, to a User Equipment (UE), a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. In some examples, the apparatus is configured to receive, from the UE, a channel measurement report indicating one or more predicted channel metrics associated with at least a subset of the second set of resources based on the beamforming codebook and the first set of resources.

Certain aspects are directed to a non-transitory computer-readable medium having instructions stored thereon that, when executed by an apparatus, cause the apparatus to perform operations comprising receiving, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. In some examples, the operations include transmitting, to the network entity, a channel measurement report indicating one or more predicted channel metrics associated with at least a subset of the second set of resources based on the beamforming codebook and the first set of resources.

Certain aspects are directed to a non-transitory computer-readable medium having instructions stored thereon that, when executed by an apparatus, cause the apparatus to perform operations comprising transmitting, to a User Equipment (UE), a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. In some examples, the operations include receiving, from the UE, a channel measurement report indicating one or more predicted channel metrics associated with at least a subset of the second set of resources based on the beamforming codebook and the first set of resources.

Certain aspects are directed to an apparatus for wireless communication. In some examples, the apparatus includes means for receiving, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. In some examples, the apparatus includes means for transmitting, to the network entity, a channel measurement report indicating one or more predicted channel metrics associated with at least a subset of the second set of resources based on the beamforming codebook and the first set of resources.

Certain aspects are directed to an apparatus for wireless communication. In some examples, the apparatus includes means for transmitting, to a User Equipment (UE), a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. In some examples, the apparatus includes means for receiving, from the UE, a channel measurement report indicating one or more predicted channel metrics associated with at least a subset of the second set of resources based on the beamforming codebook and the first set of resources.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is an example of a configuration, in accordance with various aspects of the present disclosure.

FIG. 4B is an example of association between a first set of resources and a second set of resources, in accordance with various aspects of the present disclosure.

FIG. 4C is another example of association between a first set of resources and a second set of resources, in accordance with various aspects of the present disclosure.

FIG. 5A is an example of a configuration, in accordance with various aspects of the present disclosure.

FIG. 5B is an example of association between a first set of resources and a second set of resources, in accordance with various aspects of the present disclosure.

FIG. 6 is an example of a configuration, in accordance with various aspects of the present disclosure.

FIG. 7 is a diagram illustrating an example of a hardware implementation for an example apparatus.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Some of the existing techniques for beam management and beam prediction can result in significant overhead and can consume significant amount of power due to frequent reception of reference signals and tracking beam and/or channel conditions. Additionally, existing techniques for predicting beams also rely on excessing beam sweepings to accurately predict beams and/or channel metrics for beams. However, excessing beam sweepings can also consume a significant amount of power.

Accordingly, the techniques described herein reduce the overhead and power consumption for the UE for beam management and/or beam prediction and improves accuracy of a beam prediction.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

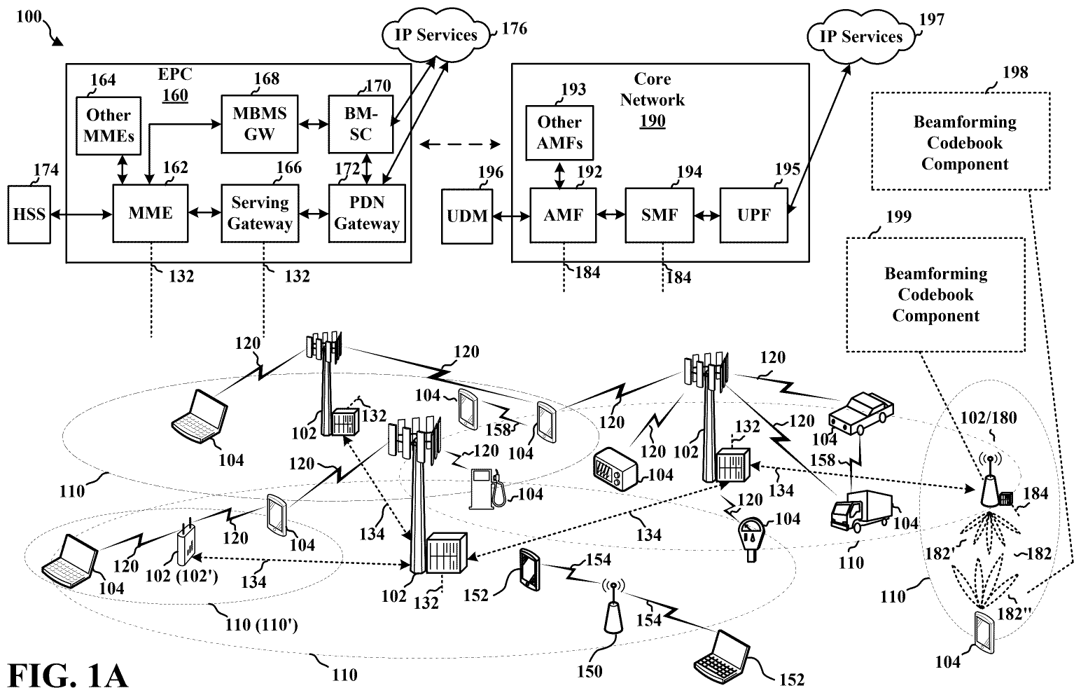

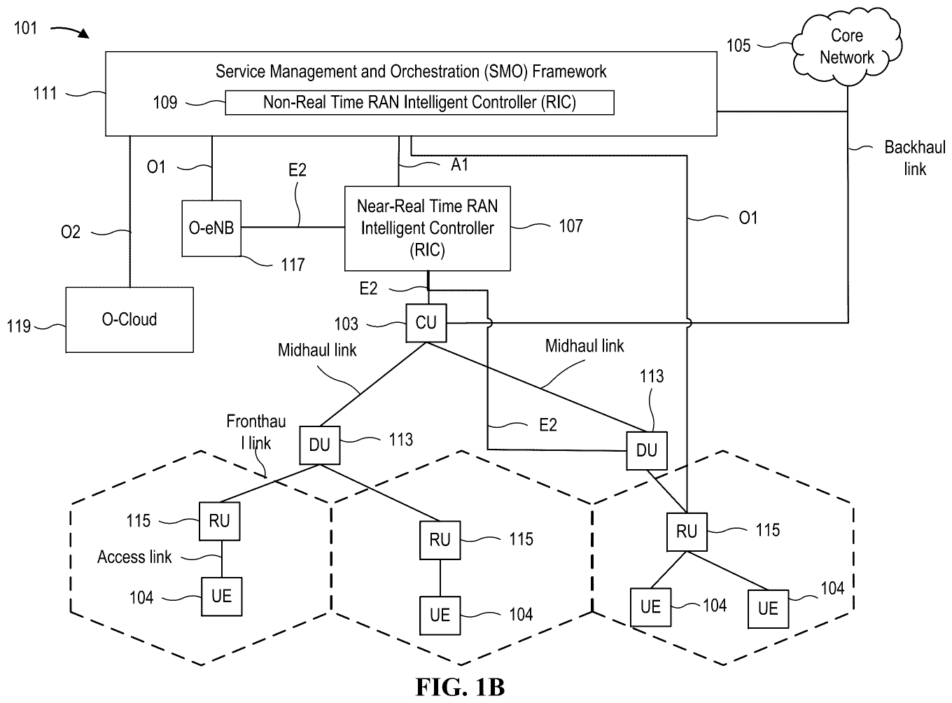

FIG. 1 is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

One or more of the UE 104 may include beamforming codebook component 198, wherein the beamforming codebook component 198 are operable to perform techniques for improving accuracy of beam prediction while reducing overhead and power consumption for UE.

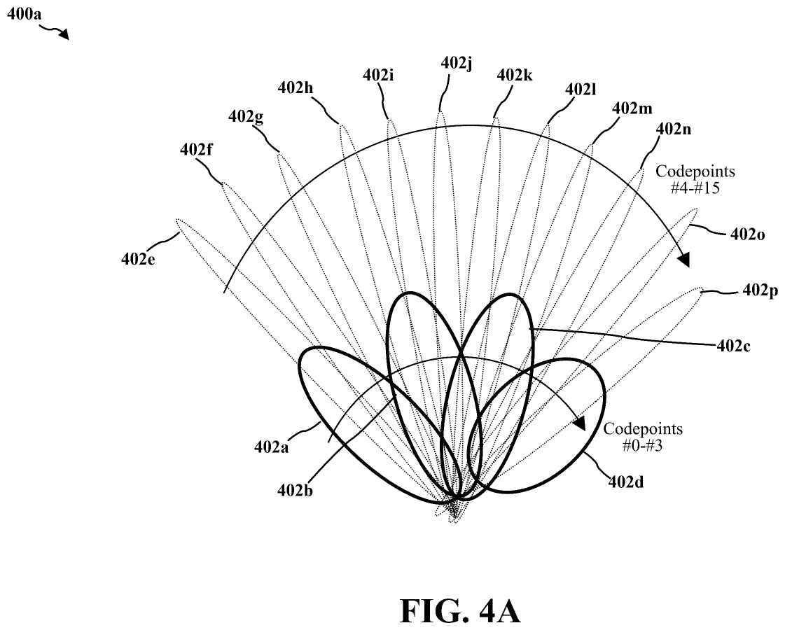

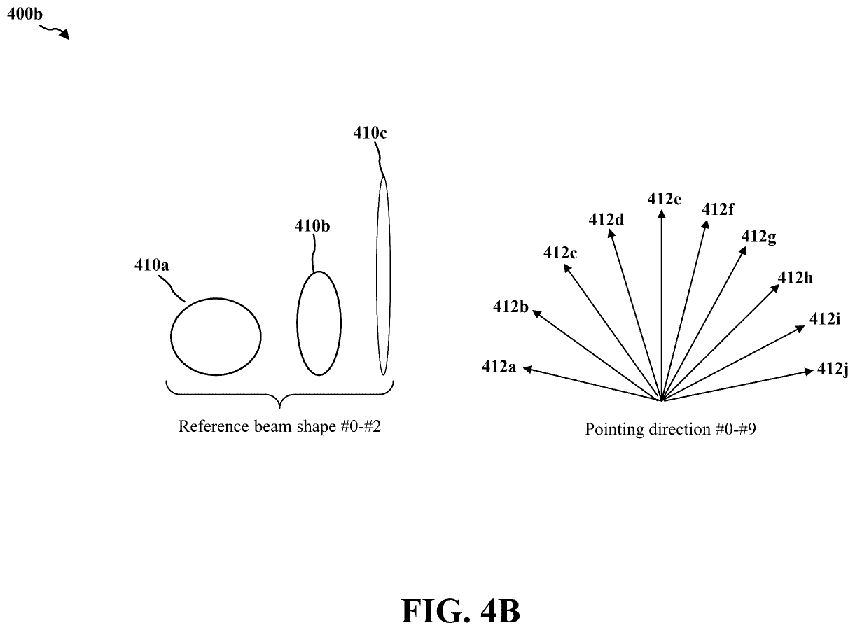

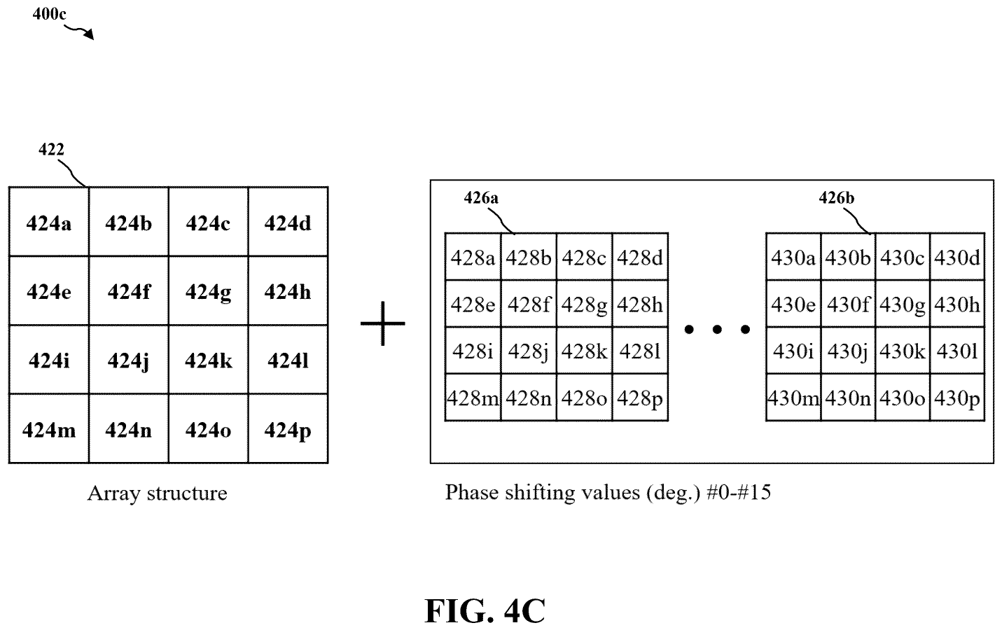

At one or more of the UEs 104, and additionally referring to FIG., the beamforming codebook component 198 includes an receiving component 720 configured to receive, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. Further, the beamforming codebook component 198 includes a transmitting component 730 configured to transmit, to the network entity, a channel measurement report indicating one or more predicted channel metrics for at least a subset of the second set of resources based on the beamforming codebook and the first set of resources. Also, in some optional or additional aspects, the beamforming codebook component 198 may include a selecting component 740, measuring component 745, and prediction component 750. Additional details of the obtaining component 720, identifying component 725, outputting component 730, selecting component 740, measuring component 745 prediction component 750 are provided below, for example, with reference to FIGS. 4A-9.

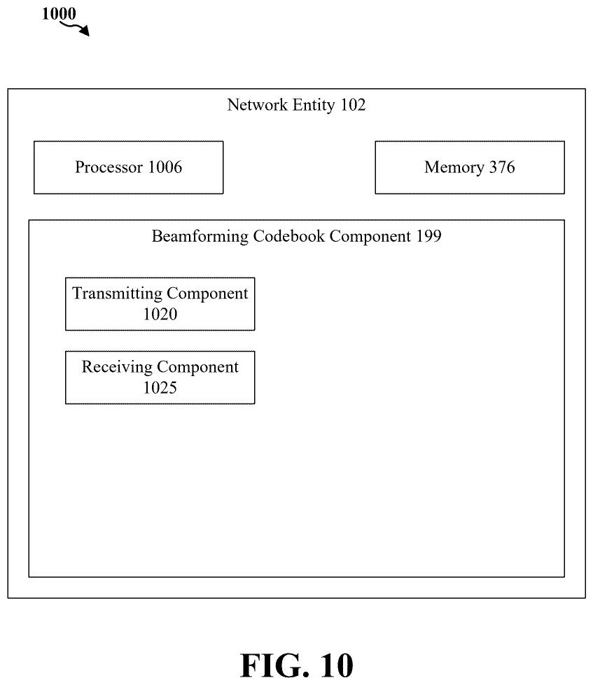

At one or more of the base stations 102/180 (or, network entities), and additionally referring to FIG. 10, the beamforming codebook component 199 includes a transmitting component 1020 configured to transmit, to a User Equipment (UE), a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. Further, the beamforming codebook component 199 includes a receiving component 1025 configured to receive, from the UE, a channel measurement report indicating one or more predicted channel metrics associated with at least a subset of the second set of resources based on the beamforming codebook and the first set of resources. Additional details are provided below, for example, with reference to FIGS. 4A-5B and 10-13.

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUS 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

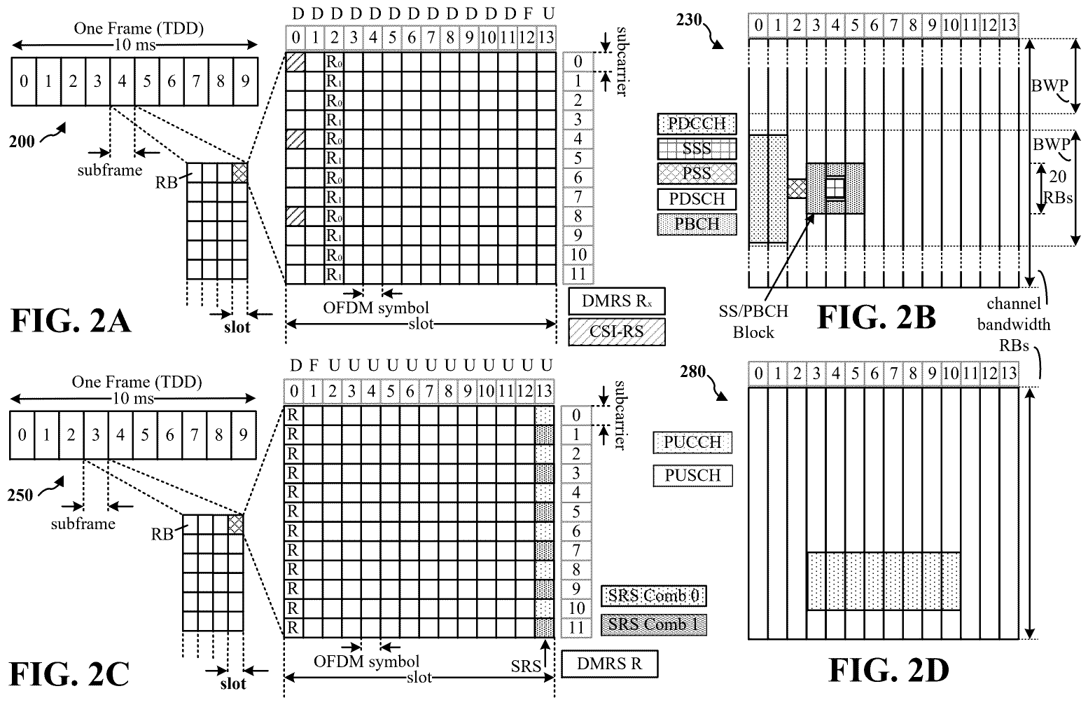

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2″ slots/subframe. The subcarrier spacing and symbol length/duration are a function of the numerology. The subcarrier spacing may be equal to kilohertz (kHz), where is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

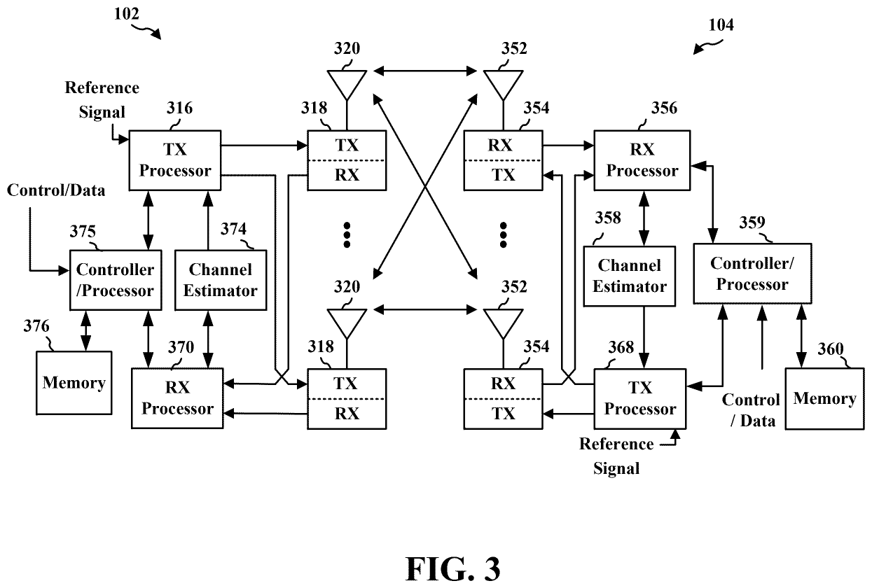

FIG. 3 is a block diagram of hardware components of the base station 102 (or 180) in communication with the UE 104 in the wireless communication network 100. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are then decoded and deinterleaved to recover the data and control signals that were originally transmitted by the base station 102 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. For example, the memory 360 may include executable instructions defining the beamforming codebook component 198. The TX processor 368, the RX processor 356, and/or the controller/processor 359 may be configured to execute the beamforming codebook component 198.

As described above, some of the existing techniques for beam prediction or predictive beam management may consume significant power resources or result in large resource overhead to achieve accurate beam predictions that satisfy latency and/or throughput requirements for data transmission via the predicted beams.

The techniques described herein can improve accuracy of beam prediction for beam management while reducing overhead and power consumption for the UE. In accordance with the aspects described herein, the UE 104 may receive (e.g., via an RRC message), from the network entity 102, a configuration indicating a beamforming codebook. The beamforming codebook may be configured per serving cell of the UE 104. For example, the configuration indicating the beamforming codebook may be a configuration of the serving cell of the UE 104 and/or may be associated with the serving cell of the UE 104. The beamforming codebook may indicate beam shapes of beams transmitted from the network entity 102 via the antenna elements of the network entity 102. In some implementations, the beamforming codebook may indicate beam shapes of beams transmitted from the network entity 102 within the serving cell of the UE 104. In some implementations, the beamforming codebook may indicate beam shapes of every beam that the network entity 102 may transmit via its antenna elements or via each of its antenna elements. The beam shapes may be indicated via one or more codepoints included in the beamforming codebook.

The UE 104 may be configured with a set of resources to be used for reporting channel metrics to network entity 102. The beam shapes indicated by the beamforming codebook may be applied to the set of resources used for reporting channel metrics. The channel metrics may be reported to the network entity 102 by indicating them in a channel measurement report (e.g., a CSI report, and/or the like) transmitted to the network entity 102 by the UE 104. The channel metrics indicated in the report may be predicted channel metrics of some of the different resources.

Some of the resources of the set of resources used for reporting channel metrics by the UE 104 may be channel measurement resources (CMRs). Examples of CMRs may be a set downlink reference signals (DL-RSs), such as SSBs, CSI-RSs, and the like. Some of the resources of the set of resources used for reporting channel metrics by the UE 104 may be a set of virtual resources or nominal resources. As described herein, a virtual or a nominal resource may be a resource not transmitted by the network entity 102 to the UE 104. In some implementations, the virtual or nominal resources may be a set of DL-RSs or associated with a set of DL-RSs that are not transmitted to the UE 104.

The UE 104 may be configured to determine a beam shape of each resource of the set of resources based on the codepoints of the beamforming codebook associated with the resource. The network entity 102 may associate a resource with a codepoint of the beamforming codebook via a configuration indicating the resource. For example, the network entity 102 may indicate the codepoint associated with the resource in an information element of the configuration indicating the resource. Additional details of configuring a beam shape of a resource via a codepoint are described infra.

When configuring and/or indicating a report of channel metrics from the UE 104, the network entity may indicate a first set of resources to be used for channel metric measurement and a second set of resources for which channel metrics may be predicted by the UE 104 without measuring. The indicated first and second set of resources may be subsets of the foregoing set of resources that the UE 104 may be configured with. In some implementations, the first set of resources may be CMRs. In some implementations, the second set of resources may be virtual resources or nominal resources that the network entity 102 may not transmit and/or that the UE 104 may be configured to not measure (e.g., not measure reference signals transmitted via the resources) for channel metrics. In some implementations, the second set of resources may be CMR and the UE 104 may be configured to not measure (e.g., not measure reference signals transmitted via the resources) for channel metrics.

The UE 104 may be configured to identify and/or determine an association between a resource of the first set of resources and a resource of the second set of resources based on the beam shapes of the two resources. The UE 104 may be configured with a set of rules and/or instructions that indicate how a resource may be associated with another resource based on the beam shapes of the resources. In some implementations, the set of rules and/or instructions may indicate that a first resource is associated with a second resource if the beam of the first resource is super positioned over the beam of the second resource. For example, the set of rules may indicate that a beam of the first resource super positions over the beam of a second resource if the beam width of a beam associated with the second resource is within the beam width of a beam associated with the first resource. Additional details of identifying and/or determining associations between the resources are described infra.

The UE 104 may be configured to predict channel metrics of at least a subset of the second set of resources based on the identified and/or determined association between the subset of second set of resources and one or more first set of resources, and based on one or more measured channel metrics of the first set of resources. Examples of channel metrics may include, but are not limited to, a reference signal received power (RSRP), a reference signal received quality (RSRQ), a sounding reference signal (SRS), a received signal strength indicator (RSSI), or a signal-to-noise and interference (SINR) ratio, rank indicators (RI), channel quality information (CQI), precoding matrix indicators (PMI), layer indicator (LI), and the like. In some implementations, the channel measurement report transmitted by the UE 104 to the network entity 102 may only be associated with the second set of resources. For example, the channel measurement report may indicate the predicted channel metrics of the subset of the second set of resources. In some implementations, the channel measurement report transmitted by the UE 104 to the network entity 102 may be associated with the first set of resources and the second set of resources. For example, the channel measurement report may indicate the predicted channel metrics of the subset of the second set of resources and the measured channel metrics of one or more resources of the first set of resources.

Referring now to FIG. 4A, example 400a shows various beam shapes associated with different beam codepoints. The example 400a includes beam shapes 402a, 402b, 402c, 402d, 402e, 402f, 402g, 402h, 402i, 402j, 402k, 4021, 402m, 402n, 4020, 402p, collectively referred to herein as beam shapes 402. As described above, the UE 104 may be configured with a beamforming codebook that includes codepoints. Each codepoint of the beamforming codebook be associated with a beamshape 402. For example, a codepoint value of 0 may be associated with beam shape 402a, a codepoint value of 1 may be associated with beam shape 402b, a codepoint value of 2 may be associated with beam shape 402c, a codepoint value of 3 may be associated with beam shape 402d, a codepoint value of 4 may be associated with beam shape 402e, a codepoint value of 5 may be associated with beam shape 402f, a codepoint value of 6 may be associated with beam shape 402g, a codepoint value of 7 may be associated with beam shape 402h, a codepoint value of 8 may be associated with beam shape 402i, a codepoint value of 9 may be associated with beam shape 402j, a codepoint value of 10 may be associated with beam shape 402k, a codepoint value of 11 may be associated with beam shape 402l, a codepoint value of 12 may be associated with beam shape 402m, a codepoint value of 13 may be associated with beam shape 402n, a codepoint value of 14 may be associated with beam shape 402o, a codepoint value of 15 may be associated with beam shape 402p.

Each of the beam shapes 402 may be defined by the network entity 102 based on the elevation and azimuth of the beam. In some implementations, the network entity 102 may define the beam shape based on a beam pointing direction, a beamforming gain, and/or a beamwidth. For example, the network entity 102 may define the beam shape based on a beam pointing direction of a beam and a beamforming gain of the beam. Similarly, the network entity 102 may define the beam shape based on a beam pointing direction of a beam and a beamwidth of the beam.

In some implementations, the beam pointing direction of a beam may be based on global coordinate system or a local coordinate system. In some implementations, the beamforming gain of a beam may be an angular-specific beamforming gain. For example, the beamforming gain of the beam may be relative to the peak gain of the beam. In some implementations, the beamwidth of a beam may be based on a 3 dB beamwidth.

In some implementations, the beams shapes associated with codepoints of the beamforming codebook may be based on predefined or preconfigured reference beam shape and/or a predefined or preconfigured beam pointing direction. Referring now to FIG. 4B, example 400b shows a set of predefined or preconfigured reference beam shapes and predefined or preconfigured beam pointing directions. The example 400b includes predefined or preconfigured reference beam shapes 410a, 410b, 410c, collectively referred to herein as predefined or preconfigured reference beam shapes 410. The example 400b further includes predefined or preconfigured beam pointing directions 412a, 412b, 412c, 412d, 412e, 412f, 412g, 412h, 412i, 412j, collectively referred to herein as beam pointing directions 412.

Examples of predefined or preconfigured reference beam shapes may include, but are not limited to, a beam with a wide beam width and a low peak beamforming gain, a beam with a medium beam width and a medium peak beamforming gain, a beam with a narrow beam width and a high peak beamforming gain, and the like. For example, beam shape 410a is a beam with a wide beam width and a low peak beamforming gain, beam shape 410b is a beam with a medium beam width and a medium peak beamforming gain, and beam shape 410c is a beam with a narrow beam width and a high peak beamforming gain.

Examples of predefined or preconfigured beam pointing directions may include, but are not limited to, beam pointing directions ranging from −45 degrees to +45 degrees in elevation and from −10 degrees to +10 degrees in azimuth. For example, elevation of beam pointing directions 412a-412j may range from −45 degrees to +45 degrees in elevation and from −10 degrees to +10 degrees in azimuth. For example, the beam pointing direction 412a may have an elevation −45 degrees and an azimuth of −10 degrees, and similarly, the beam pointing direction 412j may have an elevation of +45 degrees and an azimuth of +10 degrees.

The codepoints of the beamforming codebook may include multiple fields, where one of the fields may be associated with a predefined or preconfigured reference beam shape and another field may be associated with a predefined or preconfigured beam pointing direction. The field associated with a predefined or preconfigured reference beam shape may indicate a value associated with a beam shape 410, and the field associated with a predefined or preconfigured beam pointing direction may indicate a value associated with a beam pointing direction 412. For example, if the beam shape associated with a codepoint is based on the predefined or preconfigured reference beam shape 410b and the predefined or preconfigured beam pointing direction 412c, then the codepoint, in a field associated with the predefined or preconfigured reference beam shape, may indicate a value 1 and in a field associated with the predefined or preconfigured beam pointing direction may indicate 2. Similarly, the remaining codepoints of the beamforming codebook may indicate values associated with predefined or preconfigured reference beam shapes 410 and predefined or preconfigured beam pointing direction 412.

In some implementations, the beamforming codebook may be configured and/or indicated as an array structure corresponding to antenna and the codepoints of the beamforming codebook may be associated with a set of phase shifting values. Referring now to FIG. 4C, example 400c shows an array structure 422 of the beamforming codebook. The array structure 422 may include locations 424a, 424b, 424c, 424d, 424e, 424f, 424g, 424h, 424i, 424j, 424k, 424l, 424m, 424n, 424o, 424p, collectively referred to as locations 424. In some implementations, the array structure 422 may be correspond to the layout of antenna array of the network entity 102 or the layout of the antenna elements of the network entity 102, and orientation of the antennas of the antenna array or the antenna elements. For example, each location 424 of the array structure 422 may correspond to an antenna or an antenna element of the network entity 102, and/or their orientation. Each location 424 of the array structure 422 may include a codepoint of the beamforming codebook. For example, locations 424a, 424b, 424c, 424d, 424e, 424f, 424g, 424h, 424i, 424j, 424k, 424l, 424m, 424n, 424o, 424p may include codepoints 426a, 426b, 426c, 426d, 426e, 426f, 426g, 426h, 426i, 426j, 426k, 426l, 426m, 426n, 426o, 426p, respectively, and collectively referred to herein as codepoints 426.

Each of the codepoints 426 may be associated with a set of phase shifting values. For example, codepoint 426a may be associated with a set of phase shifting values 428a, 428b, 428c, 428d, 428e, 428f, 428g, 428h, 428i, 428j, 428k, 428l, 428m, 428n, 428o, 428p, collectively referred to herein as set of phase shifting values 428. Similarly, codepoint 426p may be associated with a set of phase shifting values 430a, 430b, 430c, 430d, 430e, 430f, 430g, 430h, 430i, 430j, 430k, 430l, 430m, 430n, 430o, 430p, collectively referred to herein as set of phase shifting values 430.

The set of phase shifting values (e.g., 428, 430) may be associated with the antennas or antenna elements of the network entity 102. For example, the phase shifting values be associated with phase shifters of the corresponding antennas or antenna elements of the network entity 102.

In some implementations, the UE 104 may receive, from the network entity 102, a configuration indicating locations of the antennas and/or antenna elements of the network entity 102. For example, the locations of the antennas and/or antenna elements of the network entity 102 may be preconfigured, and the UE 104 may receive, from the network entity 102, an RRC configuration indicating the locations of the antennas and/or antenna elements.

As described above, the beamforming codebook may be configured per serving cell of the UE 104 in some implementations. In such implementations, channel measurement reports (e.g., CSI reports, and the like) associated with different BWPs within a serving cell of the UE 104 may be associated with the same codebook. In some implementations, the beamforming codebook may be configured per BWP within a serving cell of the UE 104, and a channel measurement report associated with different BWPs within the serving cell may be associated with different codebooks. For example, a channel measurement report associated with a first BWP may be associated with the beamforming codebook configured for the first BWP, and a channel measurement report associated with a second BWP may be associated with a corresponding BWP.

As described above, the UE 104 may be configured with one or more resources, such as a SSB, CSI-RS, and/or a virtual resource. For example, the UE 104 may be configured with the one or more resources by the network entity 102. The one or more resources may be configured for a channel measurement report (e.g., CSI report) by the network entity 102. The UE 104 may receive, from the network entity 102, a configuration (e.g., a RRC configuration) indicating the one or more configured resources. For each resource of the one or more resources, a beam shape may be configured. For example, the network entity 102 may configure a beam shape of each resource of the one or more resources. The beam shape of a resource may be indicated via a codepoint of the beamforming codebook that the UE 104 may have received. The configuration indicating the one or more resources may include a corresponding codepoint for each of the one or more resources.

The configuration indicating one or more codepoints for each of the one or more resources may be different from the configuration indicating the beamforming codebook and/or the codepoints of the beamforming codebook. For example, the UE 104 may receive, from the network entity 102, the configuration indicating one or more codepoints for each of the one or more resources after the UE 104 receives the configuration indicating the beamforming codebook and/or the codepoints of the beamforming codebook.

In some implementations, for each of the one or more resources, the configuration may indicate a detailed beam shape via a codepoint as described above with reference to FIG. 4A. In some implementations, for each of the one or more resources, the configuration may indicate a reference beam shape and a reference beam pointing direction as described above with reference to FIG. 4B. In some implementations, for each of the one or more resources, the configuration may indicate a phase shifting value combination via codepoints as described above with reference to FIG. 4C. The UE 104 may receive such configurations via an RRC message from the network entity 102.

In some implementations, a set of one or more resources may be configured for a channel measurement report (e.g., CSI report), and the configuration, for each resource in the set of the one or more resources, may indicate a detailed beam shape via a codepoint as described above with reference to FIG. 4A. For example, for a set of X resources, the configuration may include and/or indicate X codepoints, each codepoint one indicating a detailed beam shape for the corresponding resource. In some implementations, for each resource in the set of one or more resources, the configuration may indicate a reference beam shape and a reference beam pointing direction as described above with reference to FIG. 4B. For example, for the set of X resources, there may be X codepoint pairs, each codepoint pair may indicate a reference beam shape and a reference beam pointing direction for the corresponding resource in the set of resources. In some implementations, for each resource in the set of one or more resources, the configuration may indicate a phase shifting value combination via codepoints as described above with reference to FIG. 4C. The UE 104 may receive, from the network entity 102, such configurations via an RRC message. For example, for the set of X resources, the configuration may include and/or indicate X codepoints, each codepoint indicating a phase shifting value combination for the corresponding resource in the set of resources. The UE 104 may receive such a configuration via an RRC configuration from the network entity 102.

In some implementations, a configuration of and/or associated with a channel measurement report (e.g., CSI report) may include and/or indicate the one or more codepoints for each of the one or more resources associated with and/or configured for the channel measurement report. For example, a CSI-ReportConfig, may indicate one or more resources or one or more sets of resources configured for a CSI report, and the CSI-ReportConfig may include and/or indicate a corresponding beam shape information (e.g., detailed beam shape, reference beam shape and reference beam pointing direction, corresponding phase shifting values, and the like) of the one or more resources or the set of resources via codepoint(s) or codepoint pair(s). In some implementations, the channel measurement report (e.g., CSI report, and the like) may be periodically scheduled or the semi-persistently scheduled and may receive the configuration of the channel measurement report via an RRC message from the network entity 102.

In some implementations, the channel measurement report may be semi-persistently scheduled and the UE 104 may receive, from the network entity 102, an activating trigger and/or message activating the semi-persistently scheduled channel measurement report. The UE 104 may receive the activating trigger and/or message via a MAC-CE (e.g., a MAC-CE message) from the network entity 102. The activating trigger and/or message may indicate one or more codepoints described above with reference to FIGS. 4A-4C for one or more configured beam shapes of the resources (e.g., SSBs, CSI-RS, virtual resources, and the like) associated with the channel measurement report.

In some implementations, the channel measurement report may be aperiodically scheduled and the UE 104 may receive, from network entity 102, an activating trigger and/or message activating the aperiodically scheduled channel measurement report. The UE 104 may receive the activating trigger and/or message via a DCI (e.g., a DCI message) from the network entity 102. The activating trigger and/or message may indicate one or more codepoints described above with reference to FIGS. 4A-4C for one or more configured beam shapes of the resources (e.g., SSBs, CSI-RS, virtual resources, and the like) associated with the channel measurement report. In some implementations, the beams shapes of the resources may be configured when the aperiodic channel measurement configuration triggering state (e.g., aperiodic CSI triggering state) associated with the aperiodic channel measurement configuration (e.g., aperiodic CSI report setting). In some implementations, the UE 104 may be configured to apply the beam shape(s) associated with the aperiodic channel measurement triggering state when the DCI that the UE 104 receives triggers the aperiodic channel measurement report (e.g., aperiodic CSI report) associated with the aperiodic channel measurement triggering state (e.g., aperiodic CSI triggering state).

As described above, the UE 104 may be configured to identify associations and/or connections between a first set of resources (or a subset of resources of the first set of resources) and a second set of resources (or a subset of resources of the second set of resources) of the resources that the UE 104 is configured with and/or the resources associated with channel measurement report. The UE 104 may be configured to identify the associations and/or connections between the first set of resources (or the subset of resources of the first set of resources) and the second set of resources (or the subset of resources of the second set of resources) based on beam width. For example, the UE 104 may identify that a resource from the second set of resources is connected to a resource from the first set of resources if the beam width of the resource from the second set of resources is within the beam width of the resource from the first set of resources.

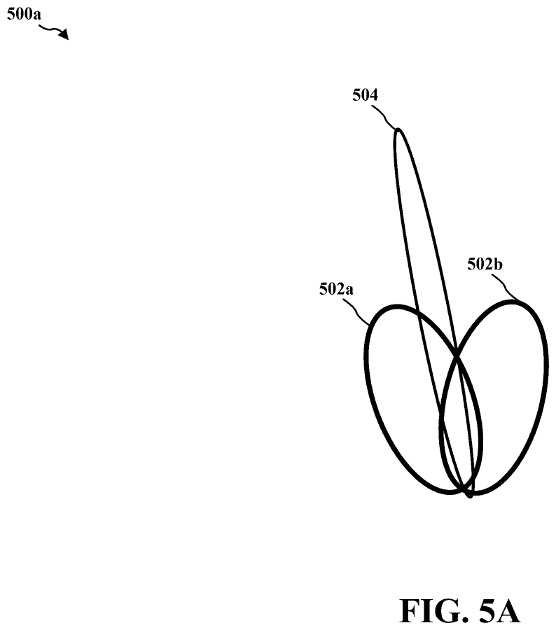

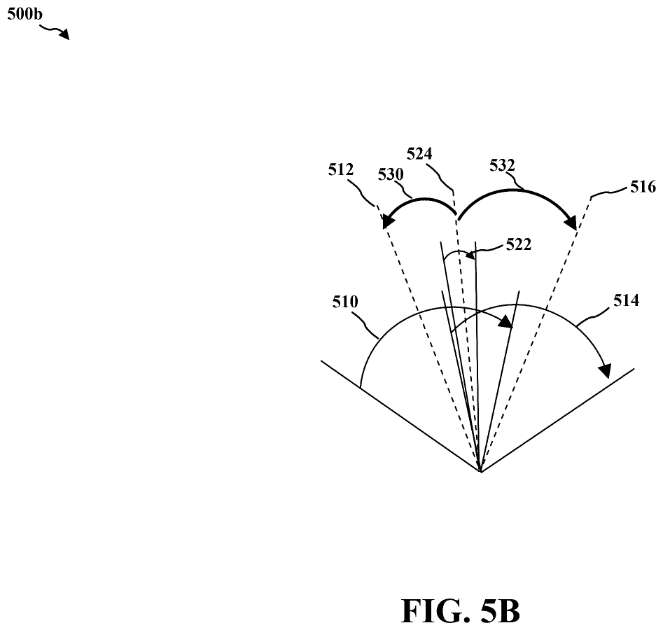

However, in some implementations, a resource from a second set of resources may overlap more than one resource from the first set of resources. Referring now to FIG. 5A, example 500, shows a resource (e.g., a beam) 504 from the second set and/or subset of resources that overlaps two resources (e.g., beams) 502a, 502b from the first set and/or subset of resources. In such implementations, the UE 104 may be configured to determine and/or identify a single resource 502a or 502b from the first set and/or subset of resources as the resource with which to connect the resource 504.

The UE 104 may determine and/or identify the single resource 502a or 502b for the resource 504 based on a set of rules and/or instructions. In some implementations, the set of rules and/or instructions may be predefined or preconfigured. In some implementations, the set of rules and/or instructions may be RRC configured (e.g., a configuration received via an RRC message from the network entity 102). In some implementations, the UE 104 may receive, from the network entity 102, the set of rules and/or instructions via MAC-CE (e.g., MAC-CE message). In some implementations, the UE 104 may receive, from the network entity 102, the set of rules and/or instructions via DCI (e.g., DCI message).

The set of rules and/or instructions may indicate that a resource from the second set of resources that overlaps two resources may be connected with a resource from the first set of resources based on the beam pointing direction of the resource of the second set of resources and the beam pointing directions of the resources of the first set of resources. For example, a resource from the first set of resources with a beam pointing direction closest to the beam pointing direction of the resource from the second set of resources is determined and/or identified as being connected to the resource from the second set of resources.

Referring to FIG. 5B, example 500b, shows a beam width 522 (e.g., X2 dB) and beam pointing direction 524 of beam 504, beam width 510 (e.g., X1 dB) and beam pointing direction 512 of beam 502a, and beam width 514 (e.g., X1 dB) and beam pointing direction 516 of beam 502b. The UE 104 may be configured to determine whether a beam pointing direction 524 of beam 504 is closest to beam pointing direction 512 of beam 502a or a beam pointing direction 516 of beam 502b based on a difference 530 between the beam pointing directions 524 and 512 and a difference 532 between the beam pointing directions 524 and 516. In some implementations, the UE 104 may be configured to determine the that the beam pointing direction 524 of beam 504 is closest to beam 502a or the if the difference 530 is smaller than the difference 532, and the UE 104 may be configured to determine that the beam pointing direction 524 of beam 504 is closest to beam 502b if the difference 532 is smaller than the difference 530. As shown in FIG. 5B, the difference 530 is smaller than the difference 532, and the UE 104 may determine that the beam pointing direction 524 of beam 504 is closest to beam pointing direction 514 of beam 502a. The UE 104 may be configured to determine that beam 504 is associated with and/or connected to beam 502a based on the beam pointing direction 524 of beam 504 being closest to the beam pointing direction 514 of beam 502a. The values (e.g., X1 dB, X2 dB, and the like) of the beam widths of the resources (e.g., beams 504, 502a, 502b) may be predefined, preconfigured, received, from the network entity 102, via an RRC configuration, via a MAC-CE indication (e.g., via an indication in a MAC-CE message from the network entity 102), and/or DCI indication (e.g., via an indication in a DCI message from the network entity 102). In some implementations, the values of the beam widths may configured per serving cell (e.g., ServCell). In some implementations, the values of the beam widths may be configured and/or indicated by a configuration associated with the channel measurement report (e.g., a CSI report setting) described above, a configuration (e.g., CSI resource setting) associated with the one or more resources that are configured for and/or associated with the channel measurement report (e.g., channel measurement resources) or with which the UE 104 is configured, as described above. In some implementations, the values of beam widths may be indicated by the MAC-CE activating the semi-persistently scheduled channel measurement report (e.g., CSI report), where the one or more resources (e.g., beams 502a, 502b, 504) are associated with the semi-persistently scheduled channel measurement report. In some implementations, the values of beam widths may be indicated by the MAC-CE activating the one or more resources (e.g., the semi-persistently scheduled CSI resource set) associated with the semi-persistently scheduled channel measurement report. In some implementations, the values of the beam widths may be configured for and/or associated with the aperiodic channel measurement triggering state configurations (e.g., aperiodic CSI triggering state configurations), and the beam width values may be indicated by the DCI when the channel measurement report (e.g., CSI report) associated with the aperiodic channel measurement triggering state (e.g., aperiodic CSI triggering state) is triggered by the DCI.

In some implementations, the UE 104 may be configured to select a machine learning model from one or more machine models with which the UE 104 is configured based on the identified associations and/or connections between the first set of resources and the second set of resources. Examples of such machine learning models may include, but are not limited to, neural network (NN) models. In some implementations, the UE 104 may be configured to measure one or more channel metrics for the first set of resources. The UE 104 may be configured to predict one or more channel metrics for the second set of resources based on an output of the selected machine learning model. In some implementations, the measured channel metric(s) may be provided as an input to the selected machine learning model. In some implementations, the UE 104 may be configured to determine the strongest or the highest measured channel metric (e.g., strongest L1-RSRP) of a resource from the first set of resources and the UE 104 may include only predicted channel metrics of the resources, from the second set of resources, that are identified as being associated with and/or connected to the resource from the first set of resources with the strongest or the highest measured channel metric. In some implementations, the network entity 102 may indicate a resource from the second set of resources (e.g., beam 504) as a quasi collocated (QCL) source and the UE 104 may be configured to receive any scheduled data or information at future time instances using a beam (e.g., an Rx beam) used to receive a resource from the first set of resources that is identified as being associated with or connected to the resource from the second set of resources.

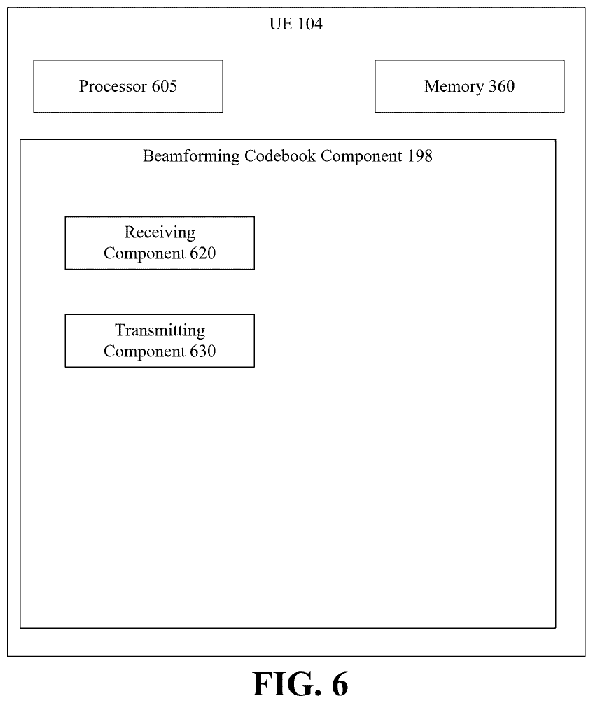

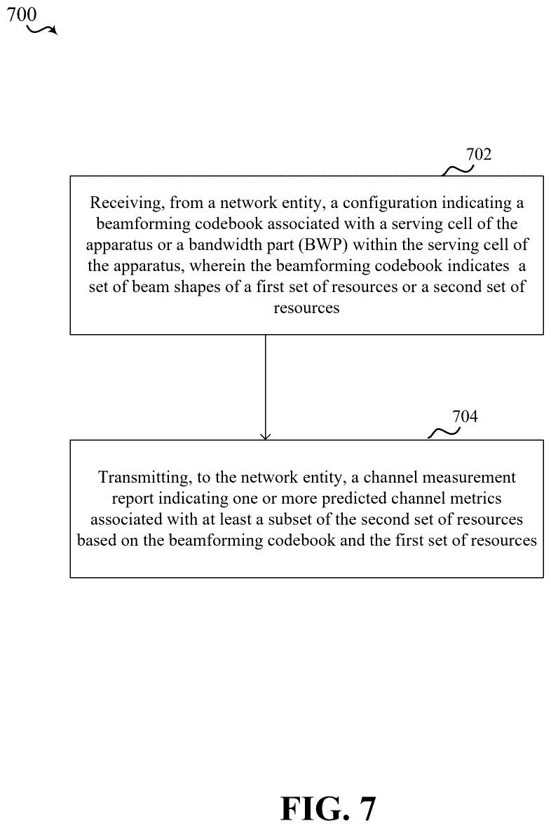

Referring to FIG. 6 and FIG. 7, in operation, UE 104 may perform a method 800 of wireless communication, by such as via execution of Beamforming Codebook Component 198 by processor 605 and/or memory 360 (FIG. 3). In this case, the processor 605 may be the receive (rx) processor 356, the controller/processor 359, and/or the transmit (tx) processor 368 described above in FIG. 3.

At block 702, the method 700 includes receiving, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. For example, in an aspect, UE 104, processor 605, memory 360, beamforming codebook component 198, and/or receiving component 620 may be configured to or may comprise means for receiving, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources.

For example, the receiving at block 702 may include receiving the configuration via a wireless signal at an antenna or antenna array (e.g., antenna 352) as described in FIG. 3.

At block 704, the method 700 includes transmitting, to the network entity, a channel measurement report indicating one or more predicted channel metrics associated with at least a subset of the second set of resources based on the beamforming codebook and the first set of resources. For example, in an aspect, UE 104, processor 605, memory 360, beamforming codebook component 198, and/or transmitting component 630 may be configured to or may comprise means for transmitting, to the network entity, a channel measurement report indicating one or more predicted channel metrics associated with at least a subset of the second set of resources based on the beamforming codebook and the first set of resources.

For example, the transmitting at block 704 may include transmitting the report via a wireless signal at an antenna or antenna array (e.g., antenna 352) as described in FIG. 3.

In alternative or additional aspect, the second set of resources are nominal reference signals that are not received by the apparatus.

In alternative or additional aspect, the one or more channel metrics are further associated with the first set of resources.

In alternative or additional aspect, the beamforming codebook comprises one or more codepoints.

In alternative or additional aspect, each codepoint of the one or more codepoints indicates a beam shape from the set of beam shapes.

In alternative or additional aspect, the beam shape is based on a beam pointing direction, a beamforming gain, and a beam width of the resource of the first set of resources or of the resource of the second set of resources.

In alternative or additional aspect, the beam pointing direction is based on a global coordinate system or a local coordinate system.

In alternative or additional aspect, the beam shape is based on a predefined beam shape and a predefined beam pointing direction.

In alternative or additional aspect, the codepoint includes a plurality of fields, and a first field of the plurality of fields indicates the predefined beam shape and a second field of the plurality of fields indicates the predefined beam pointing direction, wherein the predefined beam shape is from a set of predefined beam shapes and the predefined beam pointing direction is from a set of predefined beam pointing directions.

In alternative or additional aspect, the beamforming codebook is indicated as an array, and wherein different locations of the array are associated with different antennas of the network entity.

In alternative or additional aspect, each location of the array comprises a codepoint of the one or more codepoints, and wherein the codepoint indicates a phase shifting value of an antenna of the network entity associated with the location.

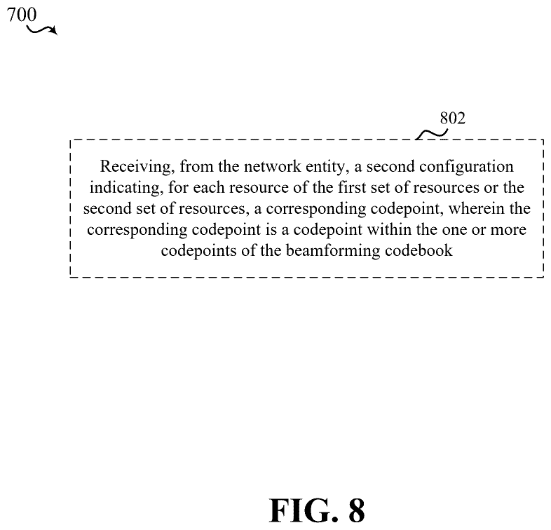

Referring to FIG. 8, in an alternative or additional aspect, at block 802, the method 700 may further include receiving, from the network entity, a second configuration indicating, for each resource of the first set of resources or the second set of resources, a corresponding codepoint, wherein the corresponding codepoint is a codepoint within the one or more codepoints of the beamforming codebook. For example, in an aspect, UE 104, processor 605, memory 360, beamforming codebook component 198, and/or receiving component 620 may be configured to or may comprise means for receiving, from the network entity, a second configuration indicating, for each resource of the first set of resources or the second set of resources, a corresponding codepoint, wherein the corresponding codepoint is a codepoint within the one or more codepoints of the beamforming codebook.

For example, the receiving at block 702 may include receiving the second configuration via a wireless signal at an antenna or antenna array (e.g., antenna 352) as described in FIG. 3.

In alternative or additional aspect, the second configuration is received via a radio resource control (RRC) message, a medium access control (MAC) control element (CE) message, or a downlink control information (DCI) message.

In alternative or additional aspect, the second configuration is associated with at least one of a periodic channel state information (CSI) report, a semi-persistence CSI report, or an aperiodic CSI report.

In alternative or additional aspect, the configuration is received via a Radio Resource Control (RRC) message, a medium access control (MAC) control element (CE) message, or a downlink control information (DCI) message.

In alternative or additional aspect, the subset of the second set of resources are associated with a resource from the first set of resources based on beam shapes of the subset of resources and a beam shape of the first set of resources.

In alternative or additional aspect, a beam width of each resource of the subset of the second set of resources is within a beam width of the resource from the first set of resources.

In alternative or additional aspect, a measured value of a channel metric of the resource from the first set of resources is greater than measured values of the channel metric of the remaining resources in the first set of resources, and the one or more predicted channel metrics are only associated with the subset of the second set of resources.

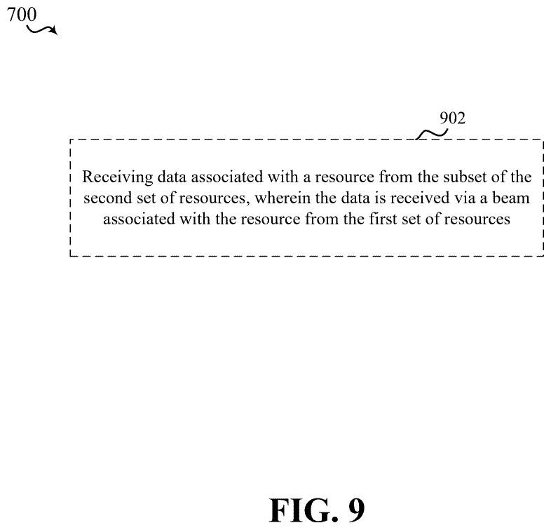

Referring to FIG. 9, in an alternative or additional aspect, at block 902, the method 700 may further include receiving data associated with a resource from the subset of the second set of resources, wherein the data is received via a beam associated with the resource from the first set of resources. For example, in an aspect, UE 104, processor 605, memory 360, beamforming codebook component 198, and/or receiving component 620 may be configured to or may comprise means for receiving data associated with a resource from the subset of the second set of resources, wherein the data is received via a beam associated with the resource from the first set of resources.

For example, the receiving at block 702 may include receiving the configuration via a wireless signal at an antenna or antenna array (e.g., antenna 352) as described in FIG. 3.

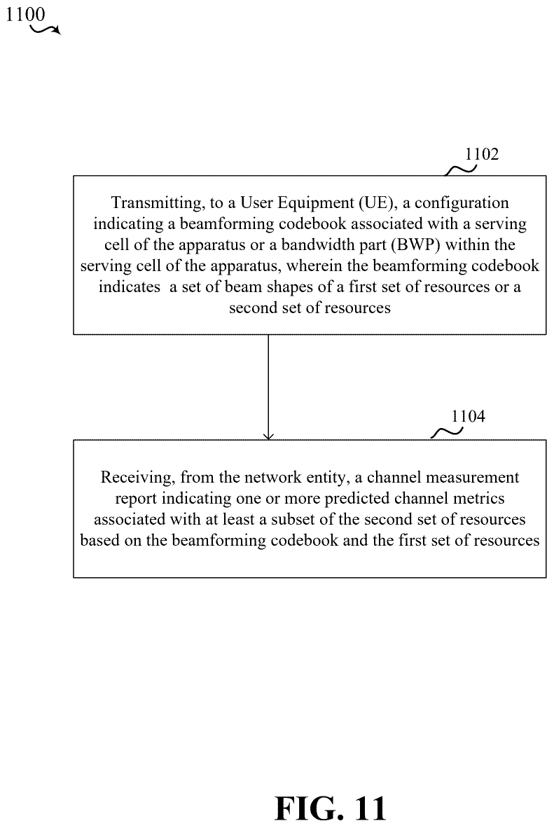

Referring to example 1000 of FIG. 10 and FIG. 11, in operation, network entity 102 may perform a method 1100 of wireless communication, by such as via execution of beamforming codebook component 199 by processor 1006 and/or memory 376 (FIG. 3). In this case, the processor 1006 may be the receive (rx) processor 370, the controller/processor 375, and/or the transmit (tx) processor 316 described above in FIG. 3.

At block 1102, the method 1100 includes transmitting, to a User Equipment (UE), a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources. For example, in an aspect, network entity 102, processor 1006, memory 376, beamforming codebook component 199, and/or transmitting component 1020 may be configured to or may comprise means for transmitting, to a User Equipment (UE), a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources.

For example, the transmitting at block 1102 may include transmitting the configuration via one or more wireless signals transmitted using an antenna or an antenna array (e.g., antenna 320).

At block 1104, the method 1100 includes receiving, from the UE, a channel measurement report indicating one or more predicted channel metrics associated with at least a subset of the second set of resources based on the beamforming codebook and the first set of resources. For example, in an aspect, UE 104, processor 605, memory 360, beamforming codebook component 199, and/or receiving component 1025 may be configured to or may comprise means for transmitting, to the network entity, a channel measurement report indicating one or more predicted channel metrics associated with at least a subset of the second set of resources based on the beamforming codebook and the first set of resources.

In alternative or additional aspect, the second set of resources are nominal reference signals that are not received by the apparatus and wherein the one or more channel metrics are further associated with the first set of resources.

In alternative or additional aspect, the beamforming codebook comprises one or more codepoints, and wherein each codepoint of the one or more codepoints indicates a beam shape from the set of beam shapes.

In alternative or additional aspect, the beam shape is based on a beam pointing direction, a beamforming gain, and a beam width of the resource of the first set of resources or of the resource of the second set of resources.

In alternative or additional aspect, the beam pointing direction is based on a global coordinate system or a local coordinate system.

In alternative or additional aspect, the beam shape is based on a predefined beam shape and a predefined beam pointing direction.

In alternative or additional aspect, the beamforming codebook is indicated as an array, and wherein different locations of the array are associated with different antennas of the network entity.

In alternative or additional aspect, the codepoint includes a plurality of fields, and a first field of the plurality of fields indicates the predefined beam shape and a second field of the plurality of fields indicates the predefined beam pointing direction, wherein the predefined beam shape is from a set of predefined beam shapes and the predefined beam pointing direction is from a set of predefined beam pointing directions.

In alternative or additional aspect, each location of the array comprises a codepoint of the one or more codepoints, and wherein the codepoint indicates a phase shifting value of an antenna of the network entity associated with the location.

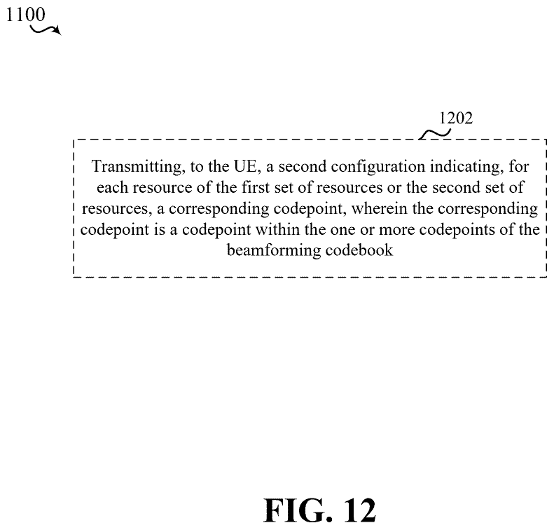

Referring to FIG. 12, in an alternative or additional aspect, at block 1202, the method 1100 may further include transmitting, to the UE, a second configuration indicating, for each resource of the first set of resources or the second set of resources, a corresponding codepoint, wherein the corresponding codepoint is a codepoint within the one or more codepoints of the beamforming codebook. For example, in an aspect, network entity 102, processor 1006, memory 376, beamforming codebook component 199, and/or transmitting component 1020 may be configured to or may comprise means for transmitting, to the UE, a second configuration indicating, for each resource of the first set of resources or the second set of resources, a corresponding codepoint, wherein the corresponding codepoint is a codepoint within the one or more codepoints of the beamforming codebook.

For example, the transmitting at block 1202 may include receiving the second configuration via a wireless signal at an antenna or antenna array (e.g., antenna 352) as described in FIG. 3.

In alternative or additional aspect, the second configuration is associated with at least one of a periodic channel state information (CSI) report, a semi-persistence CSI report, or an aperiodic CSI report.
the second configuration is transmitted via a radio resource control (RRC) message, a medium access control (MAC) control element (CE) message, or a downlink control information (DCI) message.
the configuration is transmitted via a Radio Resource Control (RRC) message, a medium access control (MAC) control element (CE) message, or a downlink control information (DCI) message.
the subset of the second set of resources are associated with a resource from the first set of resources based on beam shapes of the subset of resources and a beam shape of the first set of resources.
a beam width of each resource of the subset of the second set of resources is within a beam width of the resource from the first set of resources.
a measured value of a channel metric of the resource from the first set of resources is greater than measured values of the channel metric of the remaining resources in the first set of resources, and the one or more predicted channel metrics are only associated with the subset of the second set of resources.

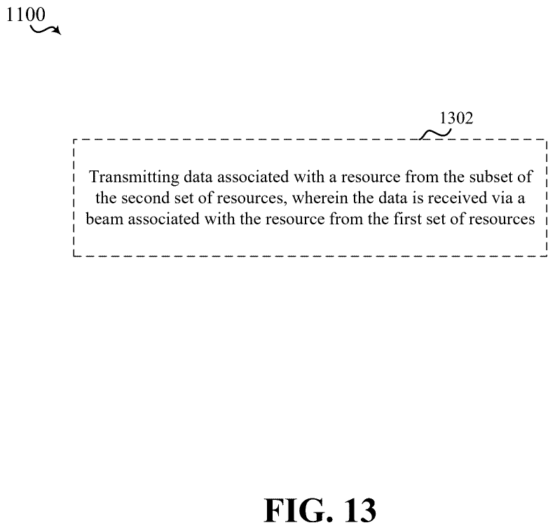

Referring to FIG. 13, in an alternative or additional aspect, at block 1302, the method 1100 may further include transmitting data associated with a resource from the subset of the second set of resources, wherein the data is received via a beam associated with the resource from the first set of resources. For example, in an aspect, network entity 102, processor 1006, memory 376, beamforming codebook component 199, and/or transmitting component 1020 may be configured to or may comprise means for transmitting data associated with a resource from the subset of the second set of resources, wherein the data is received via a beam associated with the resource from the first set of resources.

For example, the receiving at block 1302 may include transmitting the data via a wireless signal at an antenna or antenna array (e.g., antenna 352) as described in FIG. 3.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,”“when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is a method of wireless communication at a user equipment, comprising: receiving, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources; and transmit, to the network entity, a channel measurement report indicating one or more predicted channel metrics associated with at least a subset of the second set of resources based on the beamforming codebook and the first set of resources.

Example 2 is a method of example 1, wherein the second set of resources are nominal reference signals that are not received by the apparatus.

Example, 3 is a method of any of examples 1 and 2, wherein the one or more channel metrics are further associated with the first set of resources.

Example 4 is a method of any of examples 1-3, wherein the beamforming codebook comprises one or more codepoints.

Example 5 is a method of example 4, wherein each codepoint of the one or more codepoints indicates a beam shape from the set of beam shapes.

Example 6 is a method of example 5, wherein the beam shape is based on a beam pointing direction, a beamforming gain, and a beam width of the resource of the first set of resources or of the resource of the second set of resources.

Example 7 is a method of example 5, wherein the beam pointing direction is based on a global coordinate system or a local coordinate system.

Example 8 is a method of example 5, wherein the beam shape is based on a predefined beam shape and a predefined beam pointing direction.

Example 9 is a method of example 8, wherein the codepoint includes a plurality of fields, and a first field of the plurality of fields indicates the predefined beam shape and a second field of the plurality of fields indicates the predefined beam pointing direction, wherein the predefined beam shape is from a set of predefined beam shapes and the predefined beam pointing direction is from a set of predefined beam pointing directions.

Example 10 is a method of example 4, wherein the beamforming codebook is indicated as an array, and wherein different locations of the array are associated with different antennas of the network entity.

Example 11 is a method of example 10, wherein each location of the array comprises a codepoint of the one or more codepoints, and wherein the codepoint indicates a phase shifting value of an antenna of the network entity associated with the location.

Example 12 is a method of example 4, further comprising: receiving, from the network entity, a second configuration indicating, for each resource of the first set of resources or the second set of resources, a corresponding codepoint, wherein the corresponding codepoint is a codepoint within the one or more codepoints of the beamforming codebook.

Example 13 is a method of example 4, wherein the second configuration is received via a radio resource control (RRC) message, a medium access control (MAC) control element (CE) message, or a downlink control information (DCI) message.

Example 14 is a method of any of the examples 1-13, wherein the second configuration is associated with at least one of a periodic channel state information (CSI) report, a semi-persistence CSI report, or an aperiodic CSI report.

Example, 15 is a method of any of the examples 1-14, wherein the configuration is received via a Radio Resource Control (RRC) message, a medium access control (MAC) control element (CE) message, or a downlink control information (DCI) message.

Example 16 is a method of any of the examples 1-15, wherein the subset of the second set of resources are associated with a resource from the first set of resources based on beam shapes of the subset of resources and a beam shape of the first set of resources.

Example 17 is a method of example 16, wherein a beam width of each resource of the subset of the second set of resources is within a beam width of the resource from the first set of resources.

Example 18 is a method of example 16, wherein a measured value of a channel metric of the resource from the first set of resources is greater than measured values of the channel metric of the remaining resources in the first set of resources, and the one or more predicted channel metrics are only associated with the subset of the second set of resources.

Example 19 is a method of example 16, further comprising: receiving data associated with a resource from the subset of the second set of resources, wherein the data is received via a beam associated with the resource from the first set of resources.

Example 20 is a method of wireless communication at a network entity, comprising: transmitting, to a User Equipment (UE), a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources; and receive, from the UE, a channel measurement report indicating one or more predicted channel metrics associated with at least a subset of the second set of resources based on the beamforming codebook and the first set of resources.

Example 21 is a method of example 20, wherein the second set of resources are nominal reference signals that are not received by the apparatus and wherein the one or more channel metrics are further associated with the first set of resources.

Example 22 is a method of any of examples 20-21, wherein the beamforming codebook comprises one or more codepoints, and wherein each codepoint of the one or more codepoints indicates a beam shape from the set of beam shapes.

Example 23 is a method of any of examples 20-22, wherein the beam shape is based on a beam pointing direction, a beamforming gain, and a beam width of the resource of the first set of resources or of the resource of the second set of resources.

Example 24 is a method of any of examples 20-23, wherein the beam pointing direction is based on a global coordinate system or a local coordinate system.

Example 25 is a method of any of examples 20-24, wherein the beam shape is based on a predefined beam shape and a predefined beam pointing direction.

Example 26 is a method of any of examples 20-25, wherein the beamforming codebook is indicated as an array, and wherein different locations of the array are associated with different antennas of the network entity.

Example 27 is a method of example 23, wherein the codepoint includes a plurality of fields, and a first field of the plurality of fields indicates the predefined beam shape and a second field of the plurality of fields indicates the predefined beam pointing direction, wherein the predefined beam shape is from a set of predefined beam shapes and the predefined beam pointing direction is from a set of predefined beam pointing directions.

Example 28 is a method of example 23, wherein each location of the array comprises a codepoint of the one or more codepoints, and wherein the codepoint indicates a phase shifting value of an antenna of the network entity associated with the location.

Example 29 is a method of example 23, further comprising: transmitting, to the UE, a second configuration indicating, for each resource of the first set of resources or the second set of resources, a corresponding codepoint, wherein the corresponding codepoint is a codepoint within the one or more codepoints of the beamforming codebook.

Example 30 is a method of example 29, wherein the second configuration is associated with at least one of a periodic channel state information (CSI) report, a semi-persistence CSI report, or an aperiodic CSI report.

Example 31 is a method of example 22, wherein the second configuration is transmitted via a radio resource control (RRC) message, a medium access control (MAC) control element (CE) message, or a downlink control information (DCI) message.

Example 32 is a method of example 22, wherein the configuration is transmitted via a Radio Resource Control (RRC) message, a medium access control (MAC) control element (CE) message, or a downlink control information (DCI) message.

Example 33 is a method of any of examples 20-32, wherein the subset of the second set of resources are associated with a resource from the first set of resources based on beam shapes of the subset of resources and a beam shape of the first set of resources.

Example 34 is an apparatus for wireless communication comprising means for performing a method in accordance with any one of examples 1-19.

Example 35 is an apparatus for wireless communication comprising means for performing a method in accordance with any of examples 20-33.

Example 36 is a non-transitory computer-readable medium comprising instructions that, when executed by an apparatus, causes the apparatus to perform a method in accordance with any one of examples 1-19.

Example 37 is a non-transitory computer-readable medium comprising instructions that, when executed by an apparatus, causes the apparatus to perform a method in accordance with any one of examples 20-33.

Example 38 is an apparatus for wireless communications, comprising: a memory comprising instructions; and one or more processors configured to execute the instructions to cause the apparatus to perform a method in accordance with any one of examples 1-19.

Example 39 is an apparatus for wireless communications, comprising: a memory comprising instructions; and one or more processors configured to execute the instructions to cause the apparatus to perform a method in accordance with any one of examples 20-33.

1. An apparatus configured for wireless communication, comprising:
a memory comprising instructions; and
one or more processors configured to execute the instructions and cause the apparatus to:
receive, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources; and
transmit, to the network entity, a channel measurement report indicating one or more predicted channel metrics associated with at least a subset of the second set of resources based on the beamforming codebook and the first set of resources.

2. The apparatus of claim 1, wherein the second set of resources are nominal reference signals that are not received by the apparatus.

3. The apparatus of claim 1, wherein the one or more channel metrics are further associated with the first set of resources.

4. (canceled)

5. The apparatus of claim 1, wherein the beamforming codebook comprises one or more codepoints; and
wherein each codepoint of the one or more codepoints indicates a beam shape from the set of beam shapes.

6. The apparatus of claim 5, wherein the beam shape is based on a beam pointing direction, a beamforming gain, and a beam width of the resource of the first set of resources or of the resource of the second set of resources.

7-8. (canceled)

9. The apparatus of claim 5, wherein the beam shape is based on a predefined beam shape and a predefined beam pointing direction; and
wherein the codepoint includes a plurality of fields, and a first field of the plurality of fields indicates the predefined beam shape and a second field of the plurality of fields indicates the predefined beam pointing direction, wherein the predefined beam shape is from a set of predefined beam shapes and the predefined beam pointing direction is from a set of predefined beam pointing directions.

10. The apparatus of claim 1, wherein the beamforming codebook comprises one or more codepoints:
wherein the beamforming codebook is indicated as an array, and wherein different locations of the array are associated with different antennas of the network entity; and
wherein each location of the array comprises a codepoint of the one or more codepoints, and wherein the codepoint indicates a phase shifting value of an antenna of the network entity associated with the location.

11. (canceled)

12. The apparatus of claim 1, wherein the beamforming codebook comprises one or more codepoints; and wherein the one or more processors are further configured to cause the apparatus to
receive, from the network entity, a second configuration indicating, for each resource of the first set of resources or the second set of resources, a corresponding codepoint, wherein the corresponding codepoint is a codepoint within the one or more codepoints of the beamforming codebook.

13. The apparatus of claim 1, wherein the beamforming codebook comprises one or more codepoints; and
wherein the second configuration is received via a radio resource control (RRC) message, a medium access control (MAC) control element (CE) message, or a downlink control information (DCI) message.

14-15. (canceled)

16. The apparatus of claim 1, wherein the subset of the second set of resources are associated with a resource from the first set of resources based on beam shapes of the subset of resources and a beam shape of the first set of resources.

17. The apparatus of claim 16, wherein a beam width of each resource of the subset of the second set of resources is within a beam width of the resource from the first set of resources.

18. The apparatus of claim 16, wherein a measured value of a channel metric of the resource from the first set of resources is greater than measured values of the channel metric of the remaining resources in the first set of resources, and the one or more predicted channel metrics are only associated with the subset of the second set of resources.

19. The apparatus of claim 16, wherein the one or more processors are further configured to cause the apparatus to:
receive data associated with a resource from the subset of the second set of resources, wherein the data is received via a beam associated with the resource from the first set of resources.

20. An apparatus configured for wireless communication, comprising:
a memory comprising instructions; and
one or more processors configured to execute the instructions and cause the apparatus to:
transmit, to a User Equipment (UE), a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources; and
receive, from the UE, a channel measurement report indicating one or more predicted channel metrics associated with at least a subset of the second set of resources based on the beamforming codebook and the first set of resources.

21. The apparatus of claim 20, wherein the second set of resources are nominal reference signals that are not received by the apparatus and wherein the one or more channel metrics are further associated with the first set of resources.

22. (canceled)

23. The apparatus of claim 20, wherein the beamforming codebook comprises one or more codepoints, and wherein each codepoint of the one or more codepoints indicates a beam shape from the set of beam shapes; and
wherein the beam shape is based on a beam pointing direction, a beamforming gain, and a beam width of the resource of the first set of resources or of the resource of the second set of resources, or
wherein the beam pointing direction is based on a global coordinate system or a local coordinate system, or
wherein the beam shape is based on a predefined beam shape and a predefined beam pointing direction, or
wherein the beamforming codebook is indicated as an array, and wherein different locations of the array are associated with different antennas of the network entity.

24. The apparatus of claim 23, wherein the codepoint includes a plurality of fields, and a first field of the plurality of fields indicates the predefined beam shape and a second field of the plurality of fields indicates the predefined beam pointing direction, wherein the predefined beam shape is from a set of predefined beam shapes and the predefined beam pointing direction is from a set of predefined beam pointing directions.

25. The apparatus of claim 23 wherein each location of the array comprises a codepoint of the one or more codepoints, and wherein the codepoint indicates a phase shifting value of an antenna of the network entity associated with the location.

26. The apparatus of claim 23, wherein the one or more processors are further configured to cause the apparatus to:
transmit, to the UE, a second configuration indicating, for each resource of the first set of resources or the second set of resources, a corresponding codepoint, wherein the corresponding codepoint is a codepoint within the one or more codepoints of the beamforming codebook,
wherein the second configuration is associated with at least one of a periodic channel state information (CSI) report, a semi-persistence CSI report, or an aperiodic CSI report.

27-28. (canceled)

29. A method of wireless communication at a User Equipment (UE), comprising:
receiving, from a network entity, a configuration indicating a beamforming codebook associated with a serving cell of the apparatus or a bandwidth part (BWP) within the serving cell of the apparatus, wherein the beamforming codebook indicates a set of beam shapes of a first set of resources or a second set of resources; and
transmitting, to the network entity, a channel measurement report indicating one or more predicted channel metrics associated with at least a subset of the second set of resources based on the beamforming codebook and the first set of resources.

30. (canceled)
